(19) United States
(12) Patent Application Publication
(10) Pub. No.: US 2007/0183332 A1
(43) Pub. Date: Aug. 9, 2007

(54) System and method for backward congestion notification in network

(76) Inventors: Jong-Sang Oh, Suwon-si (KR); Sun-Gi Kim, Seoul (KR); Yong-Seok Park, Seongnam-si (KR)

Correspondence Address: Robert E. Bushnell, Suite 300, 1522 K Street, N.W., Washington, DC, 20005-1202, US

(21) Appl. No.: 11/654,516

(22) Filed: Jan. 18, 2007

(30) Foreign Application Priority Data
Feb. 6, 2006 (KR) 10-2006-0011356

(51) Int. Cl. H04L 12/26

(52) U.S. Cl. 370/236; 370/412; 370/252

(57) ABSTRACT

In a system and method for backward congestion notification (BcN) in a network, when it is determined in advance that congestion is imminent in the network, the system and method enable preventive reduction of packet transmission by transmitting a BcN message, requesting packet transmission reduction, to a network component transmitting packets, thereby preventing congestion and packet discard caused by network congestion.

### CLAIM OF PRIORITY

This application makes reference to, incorporates the same herein, and claims all benefits accruing under 35 U.S.C.§119 from an application for APPARATUS AND METHOD OF BACKWARD CONGESTION NOTIFICATION ON NETWORK earlier filed in the Korean Intellectual Property Office on the 6^{th} of February 2006 and there duly assigned Serial No. 10-2006-0011356.

### BACKGROUND OF THE INVENTION

1. Technical Field

The present invention relates to a system and method for backward congestion notification (BcN) in a network, and more particularly, to a BcN system and method capable of preventing congestion and packet discard caused by congestion in a network.

2. Related Art

Currently, in various networks including the Internet, there is an increasing demand for transmission of mission-critical traffic, real-time traffic, and high-priority traffic having a high added value. In order to stably transmit such traffic, a network having a high transmission speed and a high reliability is required. Such requirements coincide with the current direction of network development.

In other words, networks are currently being developed in the direction of high transmission speed and high reliability. In addition, methods for removing factors hindering fulfillment of network requirements are being suggested.

One main factor contributing to the deterioration of network reliability is congestion. Congestion may be considered as an obstructive factor in a network, and it occurs when an amount of traffic coming into the network exceeds a transmission capacity of the network. Such congestion may occur at each component, such as a router, of the network. When congestion occurs in a network component, it is also said to occur in a link including the corresponding component.

In general, when an amount of traffic exceeding the transmission capacity which can be handled in a link is applied to the link, the extra traffic exceeding the transmission capacity is lost. Therefore, congestion in a network may cause traffic loss, and thus reliability of the network deteriorates. In addition, the lost traffic may cause a request for end-to-end data retransmission in the network. Such retransmission of traffic also affects quality of service (QoS), and thus may be a factor in the deterioration of transmission performance between end-to-end users. Meanwhile, the higher the transmission speed of a network, the greater the amount of traffic which should be transmitted through the network, and thus the higher the risk of congestion in the network.

Therefore, the need for methods of coping with congestion has been increasing as well.

Methods for coping with congestion maybe classified into methods which can quickly detect and promptly clear congestion, and methods which can prevent congestion. However, all methods, such as random early detection (RED) and weighted random early detection (WRED), which have been suggested so far to cope with congestion resort to discarding packets in order to clear or prevent congestion. When congestion occurs, the methods process as many packets as can be stored in a queue of each congested port and discard packets exceeding the storage capacity, thereby clearing the congestion. Otherwise, the methods discard some packets before the network becomes congested, thereby preventing congestion. In other words, the methods suggested so far allow traffic loss by packet discard. Needless to say, such packet discard becomes a factor in the deterioration of network reliability.

Therefore, in order to improve network reliability, a method capable of preventing network congestion without discarding packets is required.

### SUMMARY OF THE INVENTION

It is an object of the present invention to provide a system and method for backward congestion notification (BcN) in a network, the system and method being capable of improving network reliability.

It is another object of the present invention to provide a system and method for BcN in a network, the system and method being capable of preventing network congestion.

It is yet another object of the present invention to provide a system and method for BcN in a network, the system and method being capable of preventing network congestion without discarding packets.

It is still another object of the present invention to provide a system and method for BcN in a network, the system and method being capable of improving data transmission performance between end-to-end users in a network.

A first aspect of the present invention provides an apparatus for BcN in a network, comprising: a detection unit for determining whether BcN is necessary according to an amount 8 of received traffic, wherein, when it is determined that BcN is necessary, the detection unit obtains and provides BcN information, including information on a traffic transmission apparatus targeted for the BcN; and a notification unit for receiving the BcN information from the detection unit, and for generating a BcN message using the BcN information.

The BcN apparatus preferably further comprises a queue for queuing the received traffic, and the detection unit compares an amount of traffic queued in the queue with a predetermined reference value. When the amount of the queued traffic exceeds the reference value, the detection unit determines that BcN is necessary.

The BcN apparatus preferably further comprises a BcN table for storing set-up information which includes the reference value, for determining whether or not BcN is necessary, and for providing the stored set-up information to the detection unit.

The BcN apparatus preferably further comprises a setting unit for configuring the BcN table.

The queue preferably comprises at least one port-specific queue space corresponding to each port for queuing the received traffic according to a port allocated to the corresponding packet, and the apparatus preferably further comprises a queuing block for classifying packets included in the received traffic according to ports, and for queuing the classified packets in queue spaces of the corresponding ports.

Each of the port-specific queuing spaces preferably comprises at least one class-specific queue space corresponding to each class for queuing the packets queued in the port-specific queue space according to classes, and the queuing block preferably classifies the packets included in the received traffic according to a port and a class allocated to each packet, and queues the classified packets in queue spaces of the corresponding ports and classes.

When receiving a packet, the detection unit preferably determines whether or not a usage quantity of the corresponding queue space exceeds the predetermined reference value due to queuing of the received packet, and when the usage amount of the queue space exceeds the reference value, the detection unit determines that BcN is necessary due to the packet.

The BcN information provided by the detection unit preferably comprises transmission information on an initial transmission apparatus of the packet necessitating BcN.

The transmission information on the initial transmission apparatus of the packet preferably comprises at least one of the sender Internet protocol (IP) address of the packet, the destination IP address of the packet, sender port information, destination port information, and class information, and the information may be included in the packet.

The apparatus preferably further comprises a transmission unit for transmitting the generated BcN message to a sender of the packet necessitating BcN.

A second aspect of the present invention provides a system for BcN in a network, the system comprising: a BcN apparatus for determining whether or not BcN is necessary, and when it is determined that BcN is necessary, the BcN apparatus generates a BcN message for the BcN and transmits the BcN message to an apparatus requiring the BcN; and a traffic transmission apparatus for reducing an amount of traffic which it transmits when receiving the BcN message from the BcN apparatus.

A third aspect of the present invention provides a method for BcN in a network, the method comprising the steps of: determining whether or not BcN is necessary; when it is determined that BcN is necessary, generating a BcN message; and transmitting the generated BcN message.

The BcN method preferably further comprises the step of obtaining BcN information to be included in the BcN message.

In the first step, an amount of traffic currently queued in a queue is preferably compared to a predetermined reference value, and when the amount of traffic queued in the queue exceeds the reference value, it is determined that BcN is necessary.

In the first step, when a packet is received, it is preferably determined whether or not the received packet requires BcN.

In the step of determining whether or not the received packet requires BcN, a current usage quantity of a queue in which the packet will be queued is compared to a predetermined reference value, and when the current usage quantity of the queue exceeds the reference value, it may be determined that the packet requires BcN.

In the third step, the generated BcN message is preferably transmitted to a sender of the packet necessitating BcN.

As described above, the present invention determines in advance whether or not network congestion is going to occur, and when it is determined that congestion is imminent, the invention performs BcN to report the situation. The BcN according to the present invention may be delivered to a traffic sender determined to be causing the imminent congestion using a BcN message. The sender, having received the BcN, may be able to prevent the congestion from occurring by adjusting an amount of traffic that he/she transmits.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an apparatus for backward congestion notification (BcN) according to an exemplary embodiment of the present invention;

FIG. 2 is a flowchart of a method for BcN according to an exemplary embodiment of the present invention;

FIG. 3 is a flowchart of a process of determining whether or not BcN is necessary according to an exemplary embodiment of the present invention;

FIG. 4 is a flowchart of a process of generating a BcN message according to an exemplary embodiment of the present invention;

FIG. 5 is a diagram of a BcN table including set-up information used for determining whether or not BcN is necessary according to an exemplary embodiment of the present invention;

FIG. 6 is a diagram of a BcN queue length table including information on a current usage quantity of a queue according to an exemplary embodiment of the present invention; and

FIG. 7 illustrates the structure of a BcN message according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

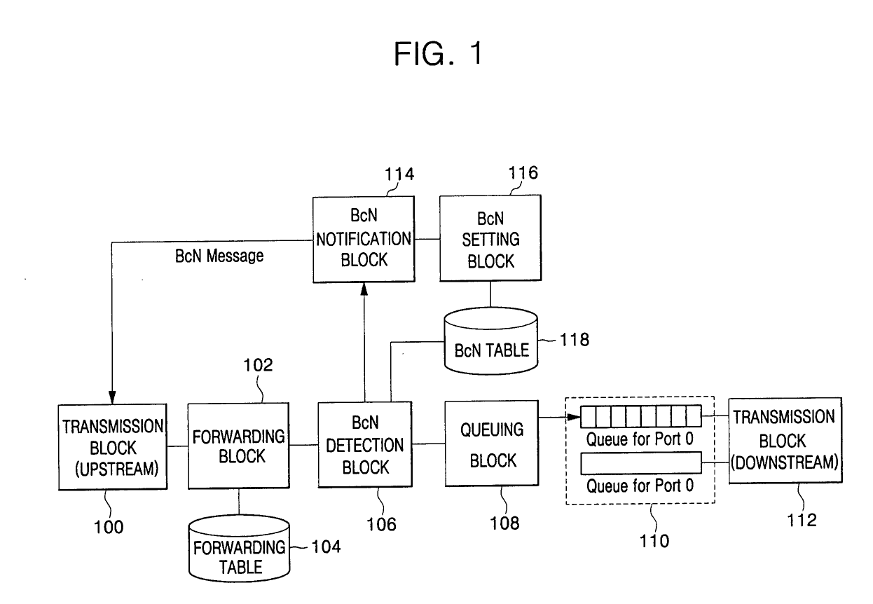

First, an apparatus for performing backward congestion notification (BcN) according to the present invention will be described. In order to report or notify of congestion when it is determined that an amount of traffic capable of causing congestion is currently being applied, the BcN apparatus according to the present invention (referred to below as “apparatus of the present invention”) may have a constitution as illustrated in FIG. 1.

FIG. 1 is a block diagram of the apparatus for BcN according to an exemplary embodiment of the present invention.

As illustrated in FIG. 1, the apparatus of the present invention comprises an upstream transmission block 100, a forwarding block 102, a forwarding table 104, a BcN detection block 106, a queuing block 108, a queue 110, a downstream transmission block 112, a BcN notification block 114, a BcN setting block 1 16, and a BcN table 118.

The upstream transmission block 100 transmits a BcN message for BcN to a sender of traffic determined to cause the congestion.

The forwarding block 102 analyzes a packet received from the outside to find out information on an output port to which the packet should be transmitted and class information, and provides the information to the BcN detection block 106 and the queuing block 108. The forwarding block 102 searches the forwarding table 104 to analyze the packet using a destination address of the packet. The forwarding table 104 stores information required for analyzing the received packet, and provides the information to the forwarding block 102.

The BcN detection block 106 detects whether or not a class of each output port is congested, and provides the result to the BcN notification block 114. In addition, when it is determined that BcN is necessary, the BcN detection block 106 preferably obtains BcN information for the BcN and provides the BcN information to the BcN notification block 114. The BcN detection block 106 may be provided with the BcN information from the forwarding block 102. The BcN detection block 106 will be described below more specifically together with the BcN notification block 114.

The queuing block 108 checks information on the packet processed by the forwarding block 102 or the BcN detection block 106, and queues the packet in the queue 110 according to a port from which the packet is transmitted and a class. Meanwhile, when there is extra space in the queue 110, the queuing block 108 queues the packet input from the BcN detection block 106 in the extra space or else discards the packet.

The queue 110 receives the packet provided from the queuing block 108 and queues the packet. In general, spaces of the queue I 10 are classified according to each port and each class of the port. Packets classified according to each port and each class in the queuing block 108 may be queued in spaces corresponding to the ports and the classes in the queue 110.

The downstream transmission block 112 determines whether or not a packet is in the queue 110 of output ports, and when there is a queued packet, transmits the packet to the corresponding output port. In this respect, the downstream transmission block 112 reduces a number of packets stored in the queue 110 by one whenever it transmits a packet.

The BcN notification block 114 generates a BcN message for BcN using the BcN information provided from the BcN detection block 106, and provides the generated BcN message to the upstream transmission block 100 so that the upstream transmission block 100 sends the generated BcN message to an initial traffic originator.

The BcN setting block 116 receives set-up information (e.g., a minimum reference value, a maximum reference value, a drop probability, and the like) used for determining whether or not BcN is necessary from a user, and configures the BcN table 118 using the set-up information. The BcN setting block 116 may also receive from the user the determination of whether or not the BcN function according to the present invention will be used. If whether or not the present invention will be used is set up to be determined by the user, the BcN function according to the present invention can be used only when the user requests the function. Alternatively, the present invention may be set up for basic use regardless of the user's request. In this case, preferably, the BcN setting block 116 receives from the user only the set-up information for configuring the BcN table 118.

The BcN table 118 stores information used for determining whether or not BcN is necessary, and provides the stored set-up information to the BcN detection block 106. In addition, the BcN table 118 may further store the information of whether or not the BcN function according the present invention will be used. The BcN table 118 may be managed according to a class of each output port. In other words, the BcN table 118 may store set-up information corresponding to a class of each output port.

The BcN detection block 106 and the BcN notification block 114 will be described in detail below.

As described above, the BcN detection block 106 determines whether or not BcN is necessary, and when it is determined that BcN is necessary, obtains BcN information for the BcN and provides the BcN information to the BcN notification block 114.

When traffic exceeds a processing capacity of the queue 110, the BcN detection block 106 determines that BcN is necessary.

More specifically, when a usage quantity of the queue 110 exceeds a predetermined reference value due to queuing of received packets, the BcN detection block 106 determines that BcN is necessary. In this respect, the BcN detection block 106 may compare a usage quantity of a corresponding queue space after the packet is queued with the predetermined reference value set up corresponding to the queue space. The packet may be referred to as a packet necessitating BcN or causing BcN. BcN may be managed according to the configuration of the queue 110. When the space of the queue 110 is configured so that packets can be queued according to an initial sender of each packet, BcN according to the present invention may be managed according to initial senders of the packets. However, in general, the queue space of a queue is configured in correspondence to ports and classes of an apparatus currently processing packets. Therefore, in general, the BcN according to the present invention also is managed according to ports and classes.

When it is determined that BcN is necessary, the BcN detection block 106 obtains the BcN information for the BcN and provides the BcN information to the BcN notification block 114. The BcN information includes information on an initial sender of a packet necessitating BcN. In particular, the information on the initial sender of the packet includes transmission information for transmitting a generated BcN message to the sender. The transmission information may include at least one of the sender Internet protocol (IP) address of the packet, the destination IP address of the packet, sender port information, destination port information, and class information. The BcN information can be obtained from the forwarding block 102.

When receiving information that BcN is necessary, and the BcN information from the BcN detection block 106, the BcN notification block 114 generates the BcN message using the BcN information. The BcN message is so generated that it can be transmitted to the initial sender of the packet necessitating BcN, and the generated BcN message is transmitted through the upstream transmission block 100.

Meanwhile, the names of components above are selected to aid in understanding the present invention, but the components are not limited by the names. Regardless of the names, the present invention can employ any components performing the functions described above.

Next, a method for BcN according to the present invention will be described.

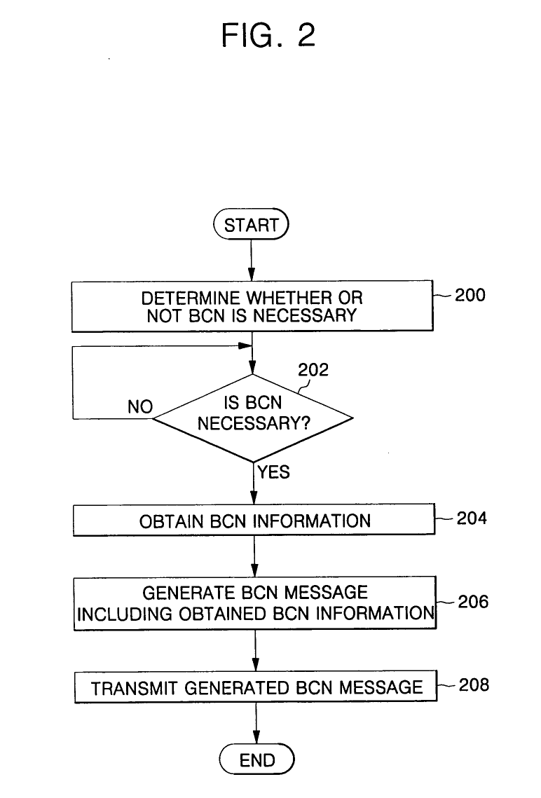

FIG. 2 is a flowchart showing a BcN method according to an exemplary embodiment of the present invention.

In step 200 of FIG. 2, it is determined whether or not BcN is necessary. When an amount of traffic currently queued in the queue 110 exceeds a predetermined reference value, it is determined that BcN is necessary. Preferably, the determination of whether or not BcN is necessary is performed for each received packet. In other words, whenever a packet is received, it may be determined whether or not an amount of traffic queued in the queue 110 exceeds the reference value due to queuing of the packet. The reference value may be stored in the BcN table 118 illustrated in FIG. 1. The packet which causes the amount of queued traffic to exceed the reference value may be referred to as a packet necessitating BcN or causing BcN. A sender of the packet necessitating BcN is a subject who will receive the BcN according to the present invention.

In step 202, a process to be subsequently performed is determined according to the determination result of step 200. When it is determined that BcN is not necessary, a general packet process may be subsequently performed without an additional operation for BcN. Conversely, when it is determined that BcN is necessary, BcN information is obtained in step 204. The BcN information may include at least information required for subsequently transmitting a BcN message. In other words, the BcN information may include transmission information on the sender of the packet necessitating BcN. The transmission information includes at least one of the sender IP address of the packet, the destination IP address of the packet, sender port information, destination port information, and class information. The information can be obtained from the packet.

Steps 200 to 204 are preferably performed by the BcN detection block 106 of FIG. 1.

In step 206, the BcN message including the BcN information obtained in step 204 is generated. Step 206 is preferably performed by the BcN notification block 114 of FIG. 1. In step 208, the message generated in step 206 is transmitted to the sender of the packet necessitating BcN. Step 208 is preferably performed by the upstream transmission block 100.

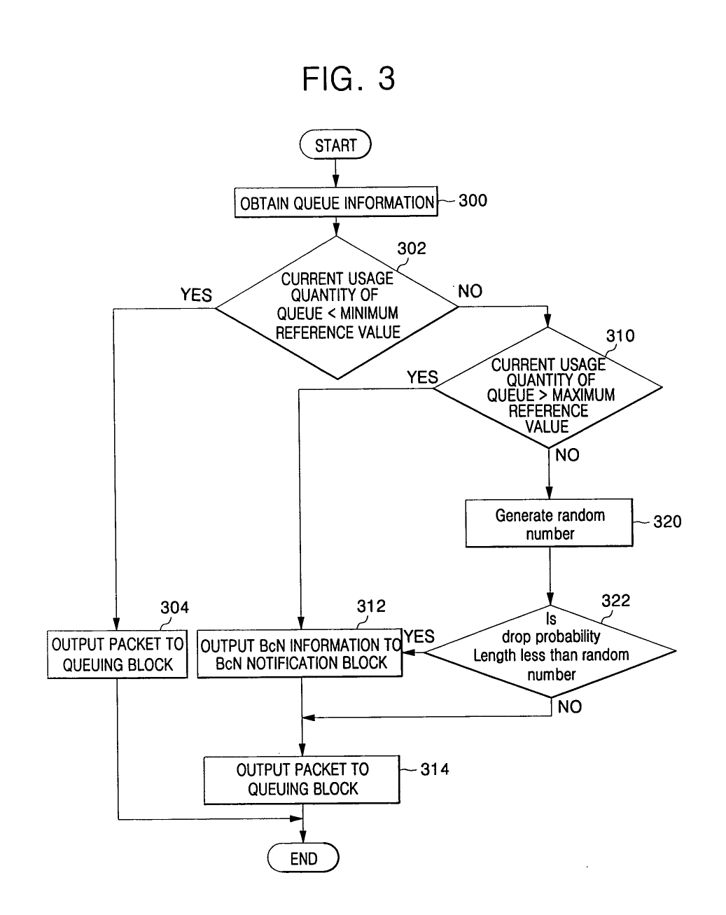

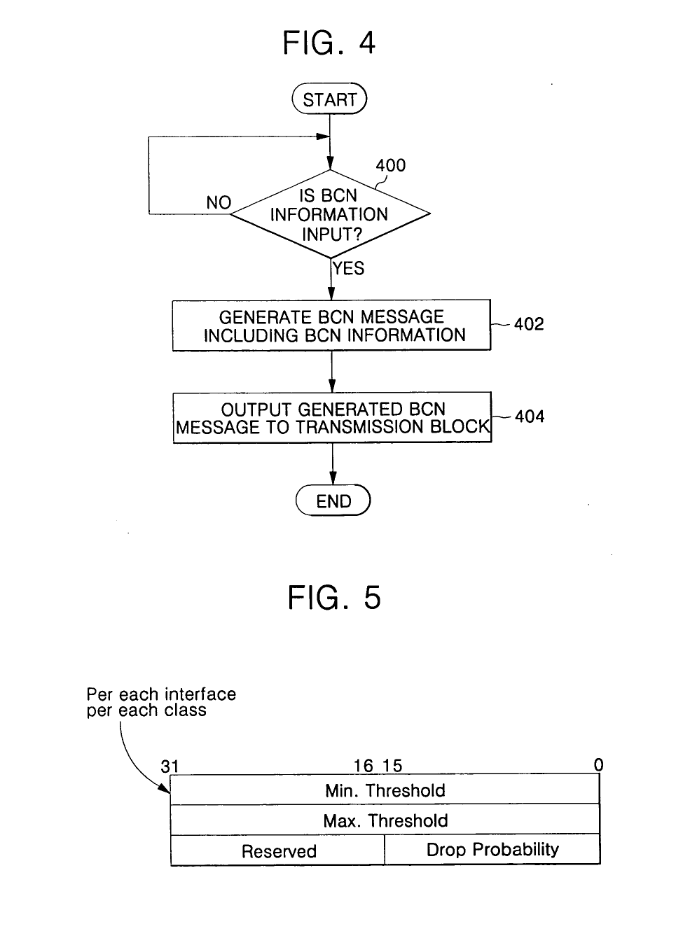

The operation of the BcN detection block 106 and the BcN notification block 114 will be described in detail below with reference to FIGS. 3 and 4.

FIG. 3 is a flowchart of a process of determining whether BcN is necessary according to an exemplary embodiment of the present invention.

An embodiment of the present invention using set-up information of a minimum reference value, a maximum reference value, and a drop probability will be suggested below. In this regard, the maximum reference value should be determined to be lower than a value actually causing congestion. This embodiment is suggested only to aid in understanding the present invention and does not limit the present invention.

In step 300, queue information and set-up information are obtained. In this regard, the BcN detection block 106 determines a queue number corresponding to a class of an output port of each packet input from the forwarding block 102, and reads out a number of packets currently stored in the corresponding queue, a maximum reference value, a minimum reference value, and a drop probability. Queue numbers may be used to indicate queue spaces in which corresponding packets are queued.

In step 302, it is determined whether or not a current usage quantity of the queue, i.e., a number of packets currently stored in the corresponding queue, is less than the minimum reference value. When the current usage quantity of the queue is less than the minimum reference value, congestion cannot occur, and thus BcN is not required. Therefore, in step 304, the corresponding packet is outputted to the queuing block 108.

On the contrary, when it is determined in step 302 that the current usage quantity of the queue is not less than the minimum reference value, it is determined in step 310 whether the current usage quantity of the queue exceeds the maximum reference value. When the current usage quantity of the queue exceeds the maximum reference value, BcN is necessary. Thus, in step 312, information that BcN is necessary is outputted to the BcN notification block 114. In this regard, the BcN detection block 106 may provide the BcN information, together with the information that BcN is necessary, to the BcN notification block 114. Then, in step 314, the corresponding packet is outputted to the queuing block 108.

On the other hand, when it is determined that the current usage quantity of the queue is not less than the minimum reference value in step 302, and is less than the maximum reference value in step 310, steps 320 and 322 of determining whether BcN is necessary according to the drop probability are performed. In step 320, a random number is generated. In step 322, the generated random number is compared to the drop probability. When the drop probability is less than the random number, it is determined that BcN is necessary, and steps 312 and 314 are executed. Conversely, when the drop probability is not less than the random number, BcN is not necessary and step 314 is executed.

Meanwhile, the determination of whether or not BcN is necessary may be performed using only one reference value rather than the maximum reference value and the minimum reference value. In addition, when needed, more than two reference values may be used to determine whether or not BcN is necessary.

FIG. 4 is a flowchart showing in detail a process of generating a BcN message according to an exemplary embodiment of the present invention.

In step 400, the BcN notification block 114 determines whether or not information that BcN is necessary and BcN information are inputted from the BcN detection block 106. Here, only the BcN information may be inputted without the additional information that BcN is necessary. When information is inputted, the BcN notification block 114 generates a BcN message using the BcN information in step 402. In step 404, the BcN notification block 114 outputs the generated BcN message to the upstream transmission block 100. The BcN message is transmitted to an initial sender of a packet necessitating BcN by the upstream transmission block 100.

Meanwhile, when receiving the BcN message, the initial sender (not shown in the drawings) of the packet necessitating BcN can prevent network congestion by reducing the amount of traffic that he/she transmits. The initial sender reduces the amount of traffic that he/she transmits in stages whenever receiving a BcN message, and increases the amount of traffic that he/she transmits when a BcN message is subsequently not received for a predetermined time, thereby enabling control of traffic coming into the network.

FIG. 5 is a diagram of a BcN table including set-up information used for determining whether or not BcN is necessary according to an exemplary embodiment of the present invention.

As illustrated in FIG. 5, the BcN table may include at least one of a minimum reference value (Min. Threshold), a maximum reference value (Max. Threshold), and a drop probability (Drop Probability), which are reference values used to determine whether or not BcN is necessary. The BcN table may be managed according to each interface and each class.

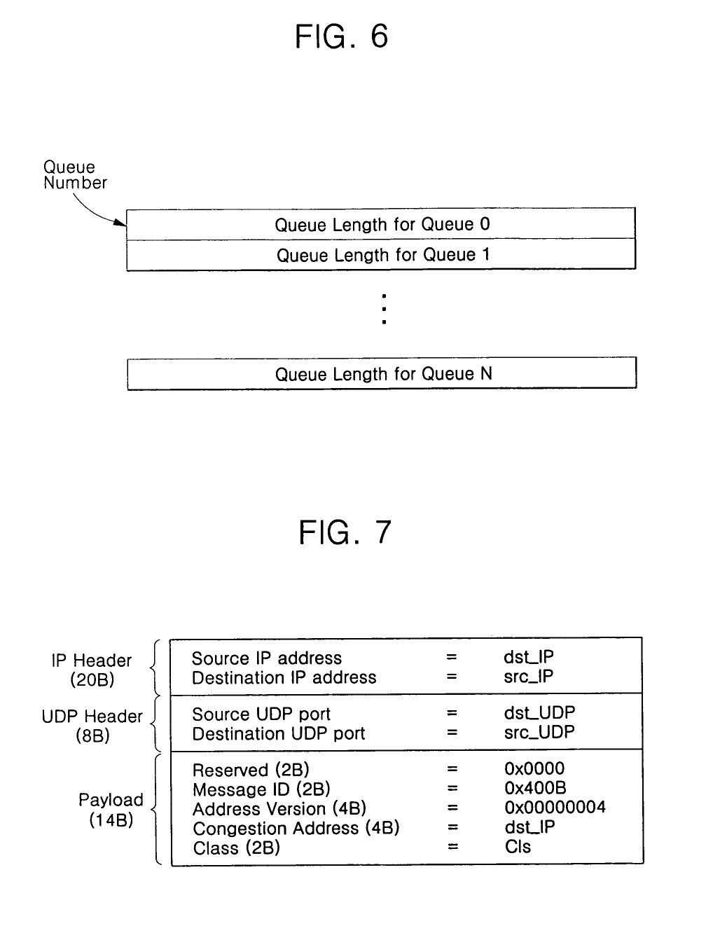

FIG. 6 is a diagram of a BcN queue length table including information on a current usage quantity of a queue according to an exemplary embodiment of the present invention.

As illustrated in FIG. 6, the BcN queue length table stores information on the current usage quantity of the queue. The table is used to determine whether or not BcN is necessary.

FIG. 7 illustrates the structure of a BcN message according to an exemplary embodiment of the present invention.

The BcN message can be used for BcN as employed in the present invention. The BcN message for the present invention includes at least address information on a subject, i.e., an initial sender of a packet necessitating BcN, who will receive the message.

If needed, the BcN message of the present invention may further include additional information such as the probability of congestion and the amount of traffic that the initial sender of the packet necessitating BcN should reduce. The information may be determined by the apparatus of the present invention. In this case, however, more set-up information such as reference values of more grades may be further required, in addition to a minimum reference value and a maximum reference value.

As described above, when it is determined that congestion is imminent, the present invention notifies a sender of traffic determined as the cause, and the sender reduces the amount of subsequently-generated traffic, thereby preventing congestion. Therefore, it is possible to prevent congestion without discarding packets, and traffic loss between users is reduced. As a result, data transmission performance between end-to-end users can be improved.

While the present invention has been described with reference to exemplary embodiments thereof, it will be understood by those skilled in the art that various changes in form and detail may be made therein without departing from the scope of the present invention as defined by the following claims.

What is claimed is:

1. An apparatus for backward congestion notification (BcN) in a network, comprising:
a detection unit for determining whether BcN is necessary according to an amount of received traffic, and when it is determined that BcN is necessary, for obtaining and outputting BcN information including information on a traffic transmission apparatus targeted for the BcN; and
a notification unit for receiving the BcN information from the detection unit, and for 8 generating a BcN message using the BcN information.

2. The BcN apparatus according to claim 1, further comprising:
a queue for queuing the received traffic;
wherein the detection unit compares an amount of traffic queued in the queue with a predetermined reference value, and when the amount of the traffic queued in the queue exceeds the reference value, the detection unit determines that BcN is necessary.

3. The BcN apparatus according to claim 2, further comprising:
a BcN table for storing set-up information which includes the reference value, the BcN table being used for determining whether BcN is necessary, and for providing the stored set-up information to the detection unit.

4. The BcN apparatus according to claim 3, further comprising:
a setting unit for receiving the set-up information from a user, and for configuring the BcN table.

5. The BcN apparatus according to claim 2, further comprising a queuing block for classifying packets included in the received traffic according to ports, and for queuing the classified packets in queue spaces of corresponding ports;
wherein the queue comprises at least one port-specific queue space corresponding to each port for queuing the received traffic according to a port allocated to a corresponding packet.

6. The BcN apparatus according to claim 5, further comprising a queuing block for classifying the packets included in the received traffic according to a port and a class allocated to each packet, and for queuing the classified packets in queue spaces of corresponding ports and classes;
wherein each port-specific queue space comprises at least one class-specific queue space corresponding to each class for queuing packets queued in the port-specific queue space according to classes.

7. The BcN apparatus according to claim 6, wherein when receiving a packet, the detection unit determines whether a usage quantity of a corresponding queue space exceeds the predetermined reference value due to queuing of the received packet, and when the usage quantity of the corresponding queue space exceeds the predetermined reference value, the detection unit determines that BcN is necessary due to the packet.

8. The BcN apparatus according to claim 7, wherein the BcN information outputted from the detection unit comprises transmission information on an initial transmission apparatus of the packet necessitating BcN.

9. The BcN apparatus according to claim 8, wherein the transmission information on the initial transmission apparatus of the packet comprises at least one of a sender Internet protocol (IP) address of the packet, a destination IP address of the packet, sender port information, destination port information, and class information, and the information is included in the packet.

10. The BcN apparatus according to claim 7, further comprising a transmission unit for transmitting the generated BcN message to a sender of the packet necessitating BcN.

11. A system for backward congestion notification (BcN) in a network, comprising:
a BcN apparatus for determining whether BcN is necessary, and when it is determined that BcN is necessary, for generating a BcN message for the BcN and transmitting the BcN message to an apparatus requiring the BcN; and
a traffic transmission apparatus responsive to reception of the BcN message from the BcN apparatus for reducing an amount of traffic that it transmits.

12. A method for backward congestion notification (BcN) in a network, comprising the steps of:
(a) determining whether BcN is necessary;
(b) when it is determined that BcN is necessary, generating a BcN message; and
(c) transmitting the generated BcN message.

13. The method according to claim 12, further comprising the step of obtaining BcN information to be included in the BcN message.

14. The method according to claim 12, where step (a) further comprises comparing an amount of traffic currently queued in a queue to a predetermined reference value, and when the amount of traffic queued in the queue exceeds the reference value, determining that BcN is necessary.

15. The method according to claim 14, wherein the predetermined reference value is previously stored in a BcN table.

16. The method according to claim 12, wherein in step (a), when a packet is received, it is determined whether the received packet requires BcN.

17. The method according to claim 16, wherein in determining whether the received packet requires BcN, a current usage quantity of a queue in which the packet will be queued is compared to a predetermined reference value, and when the current usage quantity of the queue exceeds the predetermined reference value, it is determined that the packet requires BcN.

18. The method according to claim 16, wherein BcN information is included in the BcN message, the BcN information comprising transmission information of a packet requiring BcN.

19. The method according to claim 18, wherein the transmission information of the packet requiring BcN comprises at least one of a sender Internet protocol (IP) address, a destination IP address, sender port information, destination port information, and class information of the packet, and the transmission information is included in the packet.

20. The method according to claim 19, wherein in step (c), the generated BcN message is transmitted to a sender of the packet requiring BcN.
